(19) United States
(12) Patent Application Publication
(10) Pub. No.: US 2024/0013778 A1
(43) Pub. Date: Jan. 11, 2024

(54) LAYOUT METHOD, LAYOUT APPARATUS AND PROGRAM

(71) Applicant: NIPPON TELEGRAPH AND TELEPHONE CORPORATION, Tokyo (JP)

(72) Inventors: Chihiro TAKAYAMA, Tokyo (JP); Momoko NAKATANI, Tokyo (JP); Ai NAKANE, Tokyo (JP); Yoko ISHII, Tokyo (JP)

(21) Appl. No.: 18/254,471

(22) PCT Filed: Dec. 22, 2020
(86) PCT No.: PCT/JP2020/047983

§ 371 Date: May 25, 2023

(51) Int. Cl. G10L 15/18

(52) U.S. Cl. CPC G10L 15/1815; G10L 2015/223

(57) ABSTRACT

A layout method to be executed by a computer includes generating multiple pieces of second text data using a change in a topic in first text data generated by speech recognition for a speech of a dialogue as a separator, acquiring multiple trajectories drawn in accordance with the dialogue, dividing the trajectories into multiple groups on the basis of drawn positions of the respective trajectories, associating, for each of the groups, the second text data related to drawn content indicated by a group with the group and integrating groups associated with common second text data into one group, and outputting, in response to a layout change instruction by a user, each group subjected to the associating, in a layout in accordance with the layout change instruction.

### TECHNICAL FIELD

The present invention relates to a layout method, a layout device, and a program.

### BACKGROUND ART

In related art, various methods for looking back on a meeting during the meeting or after the meeting have been proposed. As a method for recording a meeting, not only a method in which meeting minutes are created with characters in related art but also a graphical recording method using illustrations, photographs, and the like, corresponding to discussion content have been proposed. As for a medium to be used for recording, a method in which handwriting operation is recorded as digital data using not only physical paper and a pen but also a touch panel such as a capacitive touch panel, a pressure-sensitive touch panel, and an optical touch panel and a digital pen has been devised.

For example, Patent Literature 1 proposes a system and a method for supporting look-back by editing and recording meeting minutes while searching for and displaying illustrations using a result of speech recognition.

In general, such a recording method is considered to have an effect of drawing meeting minutes in real time at a position where participants can see the meeting minutes while a creator of the meeting minutes grasps content of discussion, thereby allowing the discussion to be converged by sharing points, or diverging the discussion by evoking ideas from images such as illustrations and photographs.

Furthermore, in such a recording method, various layouts are used, such as a layout in which recorded content is described in chronological order from top to bottom, a layout in which recorded content is arranged in contrast to left and right, and a layout that spreads radially from the center according to related keywords, in accordance with flow and a structure of the discussion.

### CITATION LIST

### Patent Literature

Patent Literature 1: JP 6339529 B

### SUMMARY OF INVENTION

### Technical Problem

In discussion, or the like, in which a point is not determined in advance, a meeting minute creator needs to draw graphics in an easy-to-understand manner while understanding content of the discussion, considering a method for expressing the discussion as graphics, and considering a layout, and thus, the meeting minute creator is required to have a high cognitive load and a very high skill.

In a case where the meeting minute creator cannot sufficiently predict or understand the content of the discussion in advance or does not have a sufficient skill, the following problems occur.

Note that it is assumed here to create meeting minutes or look back the meeting by utilizing illustrations as digital data using a touch panel and a digital pen.

### [Upon Creation]

There is a case where the meeting minute creator cannot grasp flow of discussion and the number of points in advance depending on a type of discussion such as discussion of providing ideas and discussion of putting opinions together.

It is therefore difficult to determine a layout of the meeting minutes in advance, and it may be necessary to change the layout during creation. For example, in a case where an important point starts to be discussed as a whole later in the discussion, a situation may arise in which it is necessary to express the point in a large size in order to make it stand out, but there is not enough space to draw the graphics. In this case, in order to newly create a space, it is necessary to designate ranges of individual illustrations and rearrange positions and sizes of the illustrations.

However, changing the layout of the meeting minutes drawn on the screen in the middle requires complicated operation such as designation of a relationship between illustrations and positions of the illustrations, and thus it is difficult for the meeting minute creator who has already allocated high cognitive resources to visualize the discussion to change the layout during the discussion.

### [Look-Back]

In a case where a person who is not participating in the discussion looks at the created meeting minutes and looks back on the discussion later, in a case of meeting minutes using illustrations, photographs, and the like, it may be difficult to look back on the flow of the discussion because the meeting minutes are not necessarily recorded and laid out in chronological order.

On the other hand, if the meeting minute creator adopts a layout in which points are arranged vertically in chronological order that is often seen in meeting minutes with characters in related art, a free layout that is an advantage of graphical meeting minutes using illustrations and photographs cannot be implemented.

The present invention has been made in view of the above points and is directed to supporting creation of a dialogue record in which content of the dialogue is easily understood.

### Solution to Problem

Thus, in order to solve the above problem, a computer executes a generation step of generating a plurality of pieces of second text data using a change in a topic in first text data generated by speech recognition for a speech of a dialogue as a separator, an acquisition step of acquiring a plurality of trajectories drawn in accordance with the dialogue, a division step of dividing the plurality of trajectories into a plurality of groups on the basis of drawn positions of the respective trajectories, an association step of associating, for each of the groups, the second text data related to drawn content indicated by a group with the group and integrating groups associated with common second text data into one group, and a layout step of outputting, in response to a layout change instruction by a user, each group associated by the association step, in a layout in accordance with the layout change instruction.

### Advantageous Effects of Invention

It is possible to support creation of a dialogue record in which content of the dialogue is easily understood.

### BRIEF DESCRIPTION OF DRAWINGS

FIG. 1 is a view illustrating a hardware configuration example of a layout device 10 according to an embodiment of the present invention.

FIG. 2 is a view illustrating a functional configuration example of the layout device 10 according to the embodiment of the present invention.

FIG. 3 is a view illustrating a configuration example of topic data.

FIG. 4 is a view illustrating a configuration example of stroke data.

FIG. 5 is a view illustrating a configuration example of stroke data with a frame flag.

FIG. 6 is a view illustrating a configuration example of stroke data with main color.

FIG. 7 is a flowchart for explaining an example of processing procedure to be executed by a drawn content division unit 16.

FIG. 8 is a view illustrating a configuration example of region data.

FIG. 9 is a flowchart for explaining an example of processing procedure to be executed by an association unit 17.

FIG. 10 is a view illustrating a configuration example of connected data.

FIG. 11 is a view illustrating an example of connected data after integration.

FIG. 12 is a view illustrating a display example of an operation reception screen.

FIG. 13 is a view illustrating a display example of a space creation selection screen.

FIG. 14 is a view illustrating a display example of a layout change selection screen.

FIG. 15 is a view illustrating a first example of a layout result.

FIG. 16 is a view illustrating a second example of the layout result.

### DESCRIPTION OF EMBODIMENTS

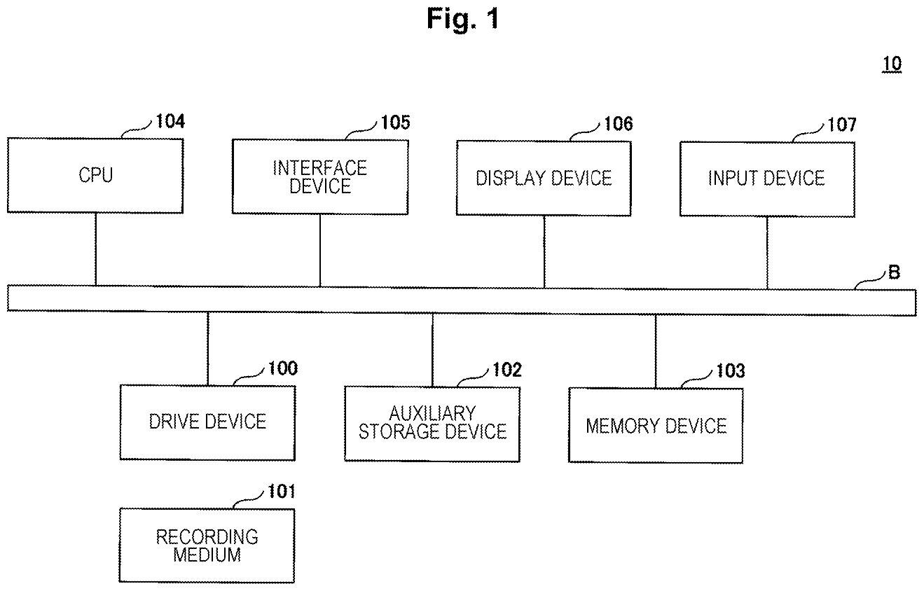

Hereinafter, embodiments of the present invention will be described with reference to the drawings. FIG. 1 is a view illustrating a hardware configuration example of a layout device 10 according to an embodiment of the present invention. The layout device 10 in FIG. 1 includes a drive device 100, an auxiliary storage device 102, a memory device 103, a CPU 104, an interface device 105, a display device 106, an input device 107, and the like, which are connected to one another via a bus B.

A program for implementing processing in the layout device 10 is provided by a recording medium 101 such as a CD-ROM. If the recording medium 101 storing the program is set in the drive device 100, the program is installed from the recording medium 101 to the auxiliary storage device 102 via the drive device 100. However, the program is not necessarily installed from the recording medium 101 and may be downloaded from another computer via a network. The auxiliary storage device 102 stores the installed program and also stores necessary files, data, and the like.

In a case where an instruction to start the program is issued, the memory device 103 reads the program from the auxiliary storage device 102 and stores the program. The CPU 104 implements a function related to the layout device 10 in accordance with the program stored in the memory device 103. The interface device 105 is used as an interface for connecting to a network. The display device 106 displays a graphical user interface (GUI), or the like, by the program. The input device 107, which includes, for example, a touch panel, a button, or the like, receives input of various operation instructions by detecting contact of a digital pen, a user's finger, or the like, with respect to the touch panel, or detecting depression of a button.

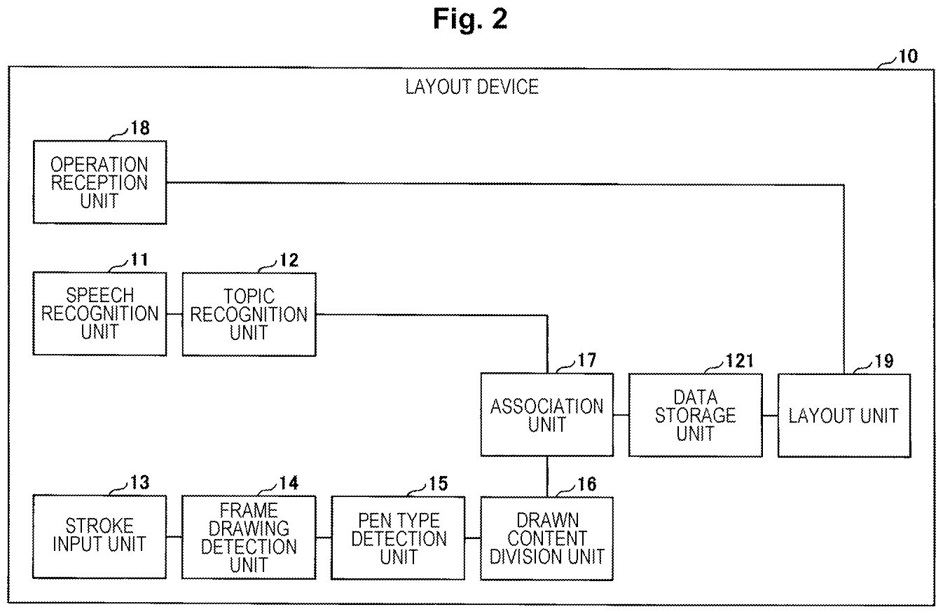

FIG. 2 is a view illustrating a functional configuration example of the layout device 10 according to the embodiment of the present invention. In FIG. 2, the layout device 10 includes a speech recognition unit 11, a topic recognition unit 12, a stroke input unit 13, a frame drawing detection unit 14, a pen type detection unit 15, a drawn content division unit 16, an association unit 17, an operation reception unit 18, and a layout unit 19. Each of these units is implemented by processing that is caused to be executed by the CPU 104 using one or more programs installed on the layout device 10. The layout device 10 also uses a data storage unit 121. The data storage unit 121 can be implemented by using, for example, the auxiliary storage device 102 or a storage device connectable to the layout device 10 via a network.

Hereinafter, each unit will be described in detail.

### [Speech Recognition Unit 11]

The speech recognition unit 11 receives input of speech waveform data of discussion (dialogue) in a meeting, or the like, in which two or more persons participate and converts the input of the speech waveform data into text data. In this event, information indicating a timing of utterance (absolute time or relative time from start of the dialogue) for each predetermined unit (for example, for each character) is added to the text data as metadata.

The speech waveform data may be acquired through a pin microphone attached to each participant of a meeting, or the like, or may be acquired through a meeting microphone that acquires audio in the environment. In the acquisition of the speech waveform data, speaker separation does not necessarily need to be performed, and any method may be used as long as the method is a method for acquiring speech waveform data that increases speech recognition accuracy. An existing speech recognition technology (for example, SpeechRec (registered trademark) (https://www.speechrec.jp/) of NTT Techno Cross, and the like), may be used for speech recognition for the speech waveform data. In addition, speaker separation may be performed on the speech waveform data using the technology disclosed in JP 5791081 B, and speaker information may be assigned to text data generated for each speaker. In this case, it is desirable that the information regarding the speaker be given as metadata regarding the text data (that is, the data is associated with the text data as data different from the text data) so as not to affect analysis processing of the text data by the topic recognition unit 12.

### [Topic Recognition Unit 12]

The topic recognition unit 12 generates a plurality of pieces of text data (hereinafter, referred to as “topic-specific text”) with a change in a topic in the text data acquired by the speech recognition unit 11 as a separator. Specifically, the topic recognition unit 12 detects start time and end time of the dialogue regarding a specific topic by detecting a position where the topic has changed (a character that is a boundary of the topic) in the text data acquired by the speech recognition unit 11. In other words, the topic recognition unit 12 sets time (hereinafter, simply referred to as “character time”) assigned as metadata to a character immediately before the position where the topic has changed as the end time of the topic before the change and sets time of the character related to the position as the start time of the topic after the change.

The change in the topic may be detected on the basis of occurrence of a certain silent period (that is, a time difference between adjacent characters is equal to or longer than a certain period) during a dialogue or may be detected on the basis of appearance of a predetermined topic change keyword (for example, “By the way”, “proceed to next”, “it's about time”, and the like), or the change in the topic may be detected from a distance to a concept vector of a word during the dialogue recognized by speech recognition using corpus data in which a semantic distance between words is recorded (JP 6210934 B).

The topic recognition unit 12 generates data including the start time and the end time of the topic, the topic-specific text from the start time to the end time, and the like, as topic data for each topic changing in time series and records the topic data in, for example, the memory device 103 or the auxiliary storage device 102. Note that the topic recognition unit 12 may extract a topic (main topic) and an important word that are main in the dialogue by applying the technology disclosed in JP 6210934 B or JP 6347938 B to the topic data and record the extracted topic and important word as another column of the topic data.

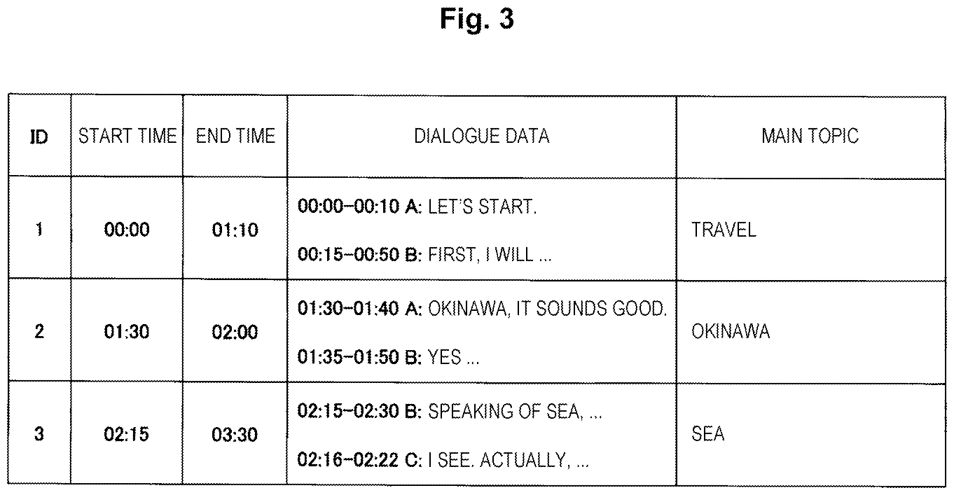

FIG. 3 is a view illustrating a configuration example of topic data. Each row in FIG. 3 corresponds to one piece of topic data. As illustrated in FIG. 3, one piece of topic data includes start time, end time, dialogue data, a main topic, and the like. The start time and the end time are the start time and the end time of the dialogue related to the topic data. The dialogue data is a character string (that is, the topic-specific text) indicating the dialogue. Note that FIG. 3 illustrates an example in which speaker separation is performed. Thus, the dialogue data is divided into character strings of utterance units of the speakers, and start time and end time of the utterance corresponding to the character string and an identifier of a speaker of the utterance are assigned to each character string as metadata.

### [Stroke Input Unit 13]

The stroke input unit 13 acquires a trajectory of a digital pen drawn by a creator of a record (hereinafter, referred to as a “dialogue record”) of a dialogue such as meeting minutes using a tablet or a screen (hereinafter, referred to as a “drawing screen”) as the display device 106 that can recognize contact of the digital pen by a method such as a capacitance method, a piezoelectric method, and an optical method and generates stroke data indicating the trajectory.

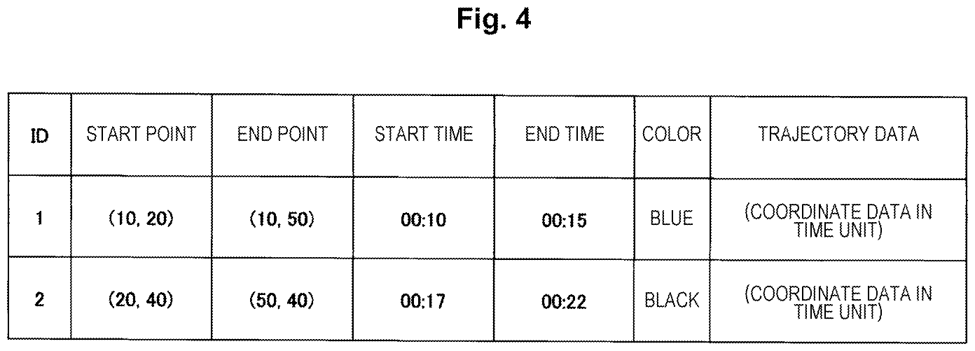

FIG. 4 is a view illustrating a configuration example of the stroke data. Each row in FIG. 4 corresponds to one piece of stroke data. As illustrated in FIG. 4, one piece of stroke data includes a start point, an end point, start time, end time, color, and trajectory data of one stroke (trajectory). Among them, the color is color of the stroke. For example, a user selects color with a button, or the like, included in the input device 107 and then performs drawing using a digital pen. The stroke input unit 13 stores selection of the color to identify the color of each stroke. Further, the trajectory data is data indicating the trajectory of the stroke and is expressed by, for example, a set of coordinate values indicating the position of the stroke in a time unit (for each fixed time period). The coordinates of the start point, the end point, and the trajectory data are, for example, coordinates in a coordinate system of the drawing screen. The stroke refers to a trajectory of a contact position of the digital pen from when the digital pen comes in contact to when the contact is released. For example, the stroke input unit 13 detects the contact of the digital pen with the drawing screen and acquires the contact position of the digital pen for each fixed time period until release of the contact is detected, so that the stroke data can be acquired for each stroke.

### [Frame Drawing Detection Unit 14]

Every time the stroke input unit 13 generates one piece of stroke data (that is, every time one stroke is drawn), the frame drawing detection unit 14 determines whether or not the stroke related to the stroke data is a frame line drawn to divide and lay out drawn content (set of strokes) during the dialogue recording (for example, whether the stroke is drawing of an illustration, a character, or the like) on the basis of a shape of the stroke.

For example, the frame drawing detection unit 14 calculates a width and a height of a minimum circumscribed rectangle of the stroke indicated by the stroke data and determines that the stroke related to the stroke data is a frame if the width or the height is equal to or greater than a certain value (for example, equal to or greater than ¼ of the width or height of the drawing screen). The frame drawing detection unit 14 generates data (hereinafter, referred to as “stroke data with a frame flag”) in which a flag (frame flag) indicating a determination result as to whether or not the stroke related to the stroke data is a frame line is added to the stroke data. Every time the stroke data with the frame flag is generated, the frame drawing detection unit 14 transmits the stroke data with the frame flag to the pen type detection unit 15.

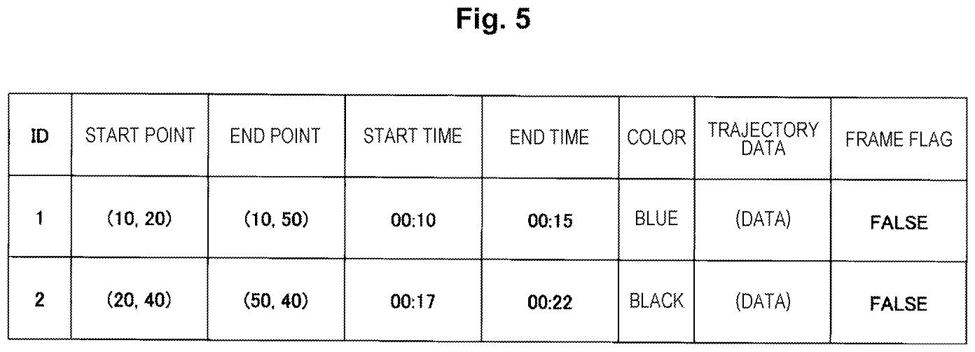

FIG. 5 is a view illustrating a configuration example of the stroke data with the frame flag. As illustrated in FIG. 5, the stroke data with the frame flag includes a frame flag in addition to the stroke data. Note that a value of the frame flag is TRUE or FALSE. TRUE indicates that the stroke is a frame line, and FALSE indicates that the stroke is not a frame line.

### [Pen Type Detection Unit 15]

Every time the stroke data with the frame flag is received, the pen type detection unit 15 determines color of a main pen on the basis of color of the stroke data with the frame flag. In graphical dialogue recording, a pen for drawing characters or figures and a pen for decorating or coloring characters or figures with shadows are separately used. The “color of the main pen” means the color of the pen for drawing characters and figures.

Specifically, the pen type detection unit 15 stores a variable of the color of the main pen in the memory device 103. The pen type detection unit 15 initializes the variable to arbitrary dark color (for example, “black”). Every time the pen type detection unit 15 receives the stroke data with the frame flag, the value of the variable is updated with color having the highest use frequency so far. The pen type detection unit 15 generates data (hereinafter, referred to as “stroke data with main color”) in which information indicating whether or not the color of the stroke data with the frame flag is the color of the main pen is added to the stroke data with the frame flag. Every time the stroke data with the main color is generated, the pen type detection unit 15 transmits the stroke data with the main color to the drawn content division unit 16.

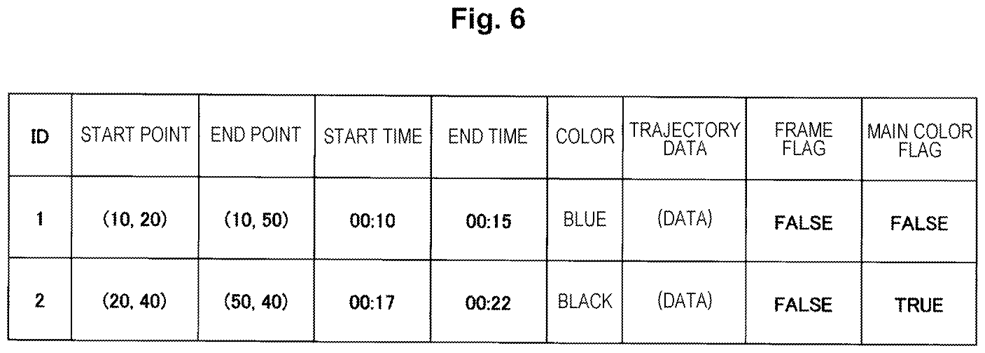

FIG. 6 is a view illustrating a configuration example of the stroke data with the main color. As illustrated in FIG. 6, the stroke data with the main color includes a main color flag in addition to the stroke data with the frame flag. Note that a value of the main color flag is TRUE or FALSE. TRUE indicates that the “color” of the stroke data with the main color is the color of the main pen. FALSE indicates that the “color” of the stroke data with the main color is not the color of the main pen.

### [Drawn Content Division Unit 16]

Every time the drawn content division unit 16 receives the stroke data with the main color from the pen type detection unit 15, the drawn content division unit 16 specifies a set of one or more pieces of stroke data with main color having a high possibility of constituting one picture or character from a group of the stroke data with the main color received so far. In other words, the drawn content division unit 16 divides the group of the stroke data with the main color (drawn content) received so far into groups for each unit constituting a picture or a character.

In such division, the drawn content division unit 16 uses information on a time interval of strokes (elapsed time period from end time of already received stroke data with main color to start time of newly received stroke data with main color) and a distance between strokes (shortest distance between uniform vicinity of the stroke related to already received stroke data with main color and a start point of newly received stroke data with main color). The drawn content division unit 16 generates region data for each group on the basis of the group of stroke data with main color belonging to the group and transmits the region data to the association unit 17.

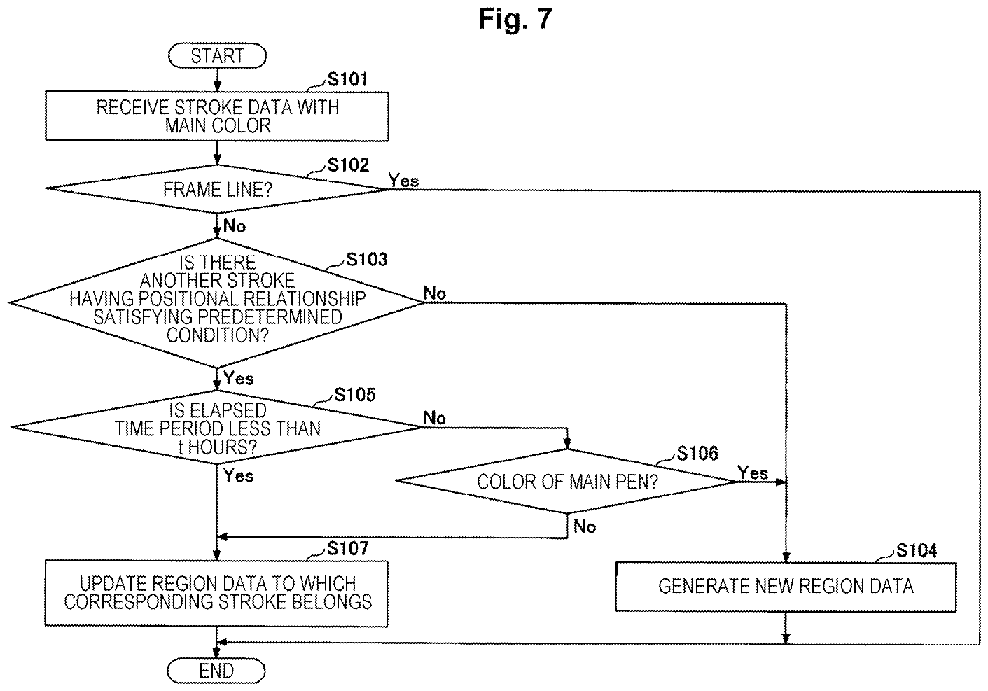

FIG. 7 is a flowchart for explaining an example of processing procedure to be executed by the drawn content division unit 16.

In step S101, the drawn content division unit 16 receives one piece of stroke data with main color (hereinafter, referred to as “target stroke data”). Subsequently, the drawn content division unit 16 determines whether or not the frame flag of the target stroke data is TRUE (that is, whether or not the stroke (hereinafter, referred to as a “target stroke”) related to the target stroke data is a frame line) (S102). In a case where the frame flag of the target stroke is TRUE (S102: Yes), the drawn content division unit 16 ends the processing related to the target stroke data. In other words, the stroke data corresponding to the frame line does not belong to any group. This means that the frame line is excluded from a layout target by the layout unit 19 to be described later.

In a case where the frame flag of the target stroke is FALSE (S102: No), the drawn content division unit 16 determines whether or not there is another stroke having a positional relationship with the target stroke satisfying a predetermined condition (S103). Here, the predetermined condition is a condition indicating that a pattern is drawn in the vicinity of the target stroke. For example, overlapping in the uniform vicinity from the target stroke by a distance r may be set as the predetermined condition. The uniform vicinity from the target stroke by the distance r refers to a region having a width of the distance r in both directions perpendicular to the target stroke and having a circular shape with a radius r at both end points of the stroke. Whether the target stroke overlaps in the uniform vicinity from another stroke can be determined on the basis of whether part of another stroke is included in the uniform vicinity. Note that r is a threshold set in advance. For example, a multiple (for example, three times) of a thickness of the digital pen may be set as a value of r. In addition, the value of r may be decreased as the number of strokes of the entire screen increases (that is, as the number of drawn pictures or characters on the screen increases).

In a case where there is another stroke having a positional relationship with the target stroke satisfying the predetermined condition (S103: No), the drawn content division unit 16 generates a new group including the target stroke and generates region data corresponding to the group (S104).

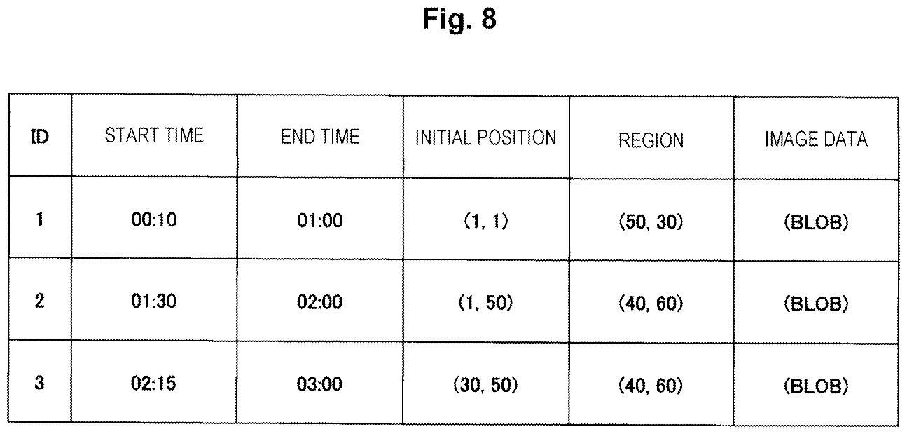

FIG. 8 is a view illustrating a configuration example of the region data. In FIG. 8, each row corresponds to one piece of region data. As illustrated in FIG. 8, each region data includes start time, end time, an initial position, a region, image data, and the like. The start time and the end time indicate a period from start of drawing of the group corresponding to the region data to end of the drawing. In other words, the start time is the earliest start time among the start time of the group of the stroke data with the main color belonging to the region data. The end time is the latest end time among the end time of the group of the stroke data with the main color belonging to the region data. The image data refers to image data generated by drawing the group of strokes with a certain thickness (for example, a thickness of a pen tip of the digital pen). The image data is generated by the drawn content division unit 16 in association with generation of the region data. The region is a width and a height of the image data. The initial position is a coordinate of an upper left vertex of the region of the image data with respect to the drawing screen.

In a case where there is another stroke having a positional relationship with the target stroke satisfying the predetermined condition (S103: Yes), the drawn content division unit 16 determines whether or not the elapsed time period from end time of near stroke data to start time of the target stroke data is less than a predetermined period (t hours) for each piece of the stroke data with the main color (hereinafter, “near stroke data”) related to one or more other strokes satisfying the predetermined condition (S105). t is a threshold set in advance (for example, 10 seconds).

In a case where there is the near stroke data for which the elapsed time period is less than t hours (S105: Yes), the drawn content division unit 16 updates the region data by adding the target stroke data to the region data related to the group to which the near stroke data belongs (S107). Specifically, the drawn content division unit 16 updates the start time, the end time, the initial position, and the region of the region data as necessary on the basis of the target stroke data and draws (records) the target stroke with respect to the image data of the region data. Note that in a case where there is a plurality of pieces of near stroke data for which t hours has not elapsed, the target stroke data may be added to the region data to which one piece of near stroke data for which a distance between the start position of the target stroke data and the uniform vicinity is the shortest belongs.

In a case where the elapsed time period is equal to or longer than t hours for any of the near stroke data (S105: No), the drawn content division unit 16 determines whether or not the main color flag of the target stroke data is TRUE (S106). In a case where the main color flag is TRUE (S106: Yes), the drawn content division unit 16 executes step S104, and in a case where the main color flag is not TRUE (S106: No), the drawn content division unit 16 executes step S107. In other words, the stroke drawn in the color of the main pen is included in the same group as the near stroke drawn t hours or more ago.

The drawn content division unit 16 transmits, for example, region data newly generated or updated for each fixed time period (for example, 5 minutes, or the like), (hereinafter, referred to as a “region data group”) to the association unit 17 in the fixed time period. In a case where there is no corresponding region data in the fixed time period, the drawn content division unit 16 does not transmit the region data.

### [Association Unit 17]

Every time the region data group (FIG. 8) is received from the drawn content division unit 16, the association unit 17 associates the topic data (FIG. 3) generated by the topic recognition unit 12 with each region data included in the region data group.

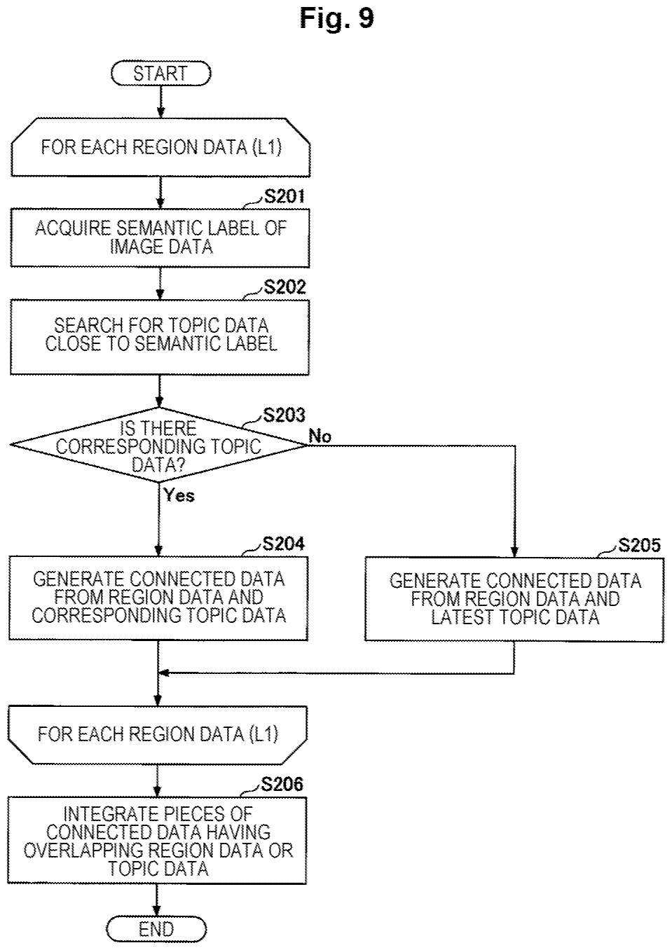

FIG. 9 is a flowchart for explaining an example of processing procedure to be executed by the association unit 17. The association unit 17 executes loop processing L1 including step S201 to step S205 for each region data included in the region data group received from the drawn content division unit 16. The region data to be processed in the loop processing L1 will be hereinafter referred to as “target region data”.

In step S201, the association unit 17 acquires a semantic label of the image data of the target region data (a label indicating meaning of an image indicated by the image data). Specifically, the association unit 17 performs optical character recognition (OCR) on the image data of the target region data and acquires character string information in the image data. In parallel, the association unit 17 performs image recognition processing using image dictionary data on the image data (for example, JP 6283308 B) and identifies and labels an object in the image data. The association unit 17 selects one of the character string information and the identification and labeling of the object with higher recognition accuracy and sets the selected information as the semantic label for the region data.

Subsequently, the association unit 17 searches for topic data including dialogue data semantically close to the semantic label from a topic data group of N pieces (hereinafter, referred to as “most recent topic data group”) in descending order of the end time backward from the end time of the target region data (S202). Note that whether or not the dialogue data is semantically close may be determined on the basis of whether or not there is a word matching the semantic label in the dialogue data, or whether or not there is an appearance word of which a distance (that is, a distance between a concept vector of the appearance word and a concept vector of the semantic label) from the semantic label using the concept vector is less than a threshold among the appearance words of the dialogue data.

In a case where there is one or more pieces of corresponding topic data (S203: Yes), the association unit 17 generates data obtained by connecting the target region data and each piece of corresponding topic data (hereinafter, the generated data is referred to as “connected data”) (S204). In this case, the connected data corresponding to the number of pieces of corresponding topic data is generated. In a case where there is no corresponding topic data (S203: No), the association unit 17 generates the connected data by connecting the target region data and the latest topic data in the most recent topic data group (S205). In this case, one piece of connected data is generated for the target topic data.

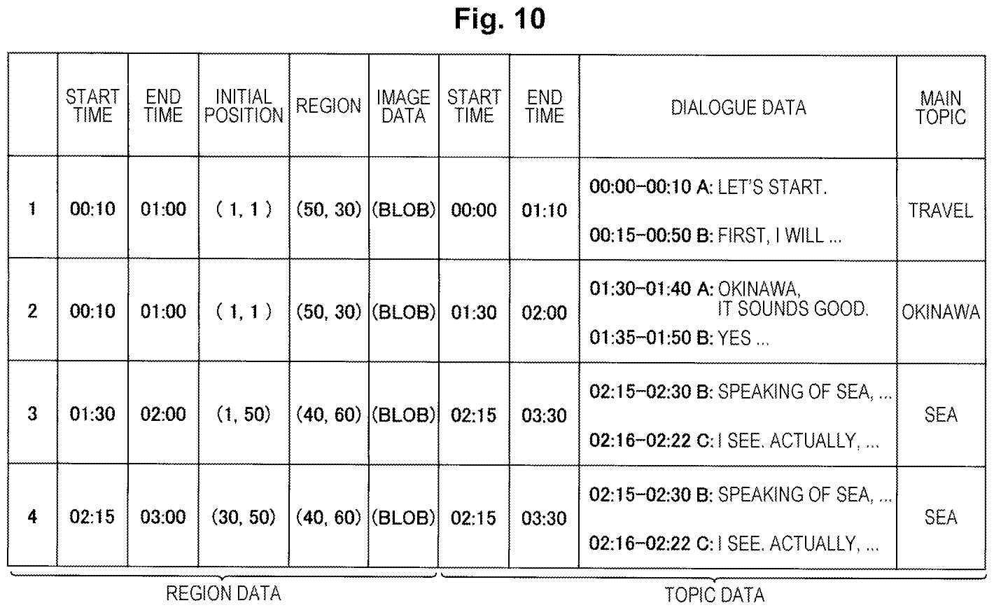

FIG. 10 is a view illustrating a configuration example of the connected data. In FIG. 10, the region data of a record of ID=1 and the region data of a record of ID=2 are common. In other words, these two records indicate examples of connected data generated in a case where a plurality of pieces of corresponding topic data is found as a result of the search in step S202.

On the other hand, the topic data of a record of ID=3 and the topic data of a record of ID=4 are common. These two records indicate examples of connected data generated by connecting one piece of topic data to one piece of region data in step S204 or step S205, in which the same topic data is connected to different region data.

If the loop processing L1 is executed for all the region data included in the region data group received from the drawn content division unit 16, if there is a connected data group having common region data or topic data in the connected data group generated in the loop processing L1, the association unit 17 integrates the corresponding connected data group into one piece of connected data (S206).

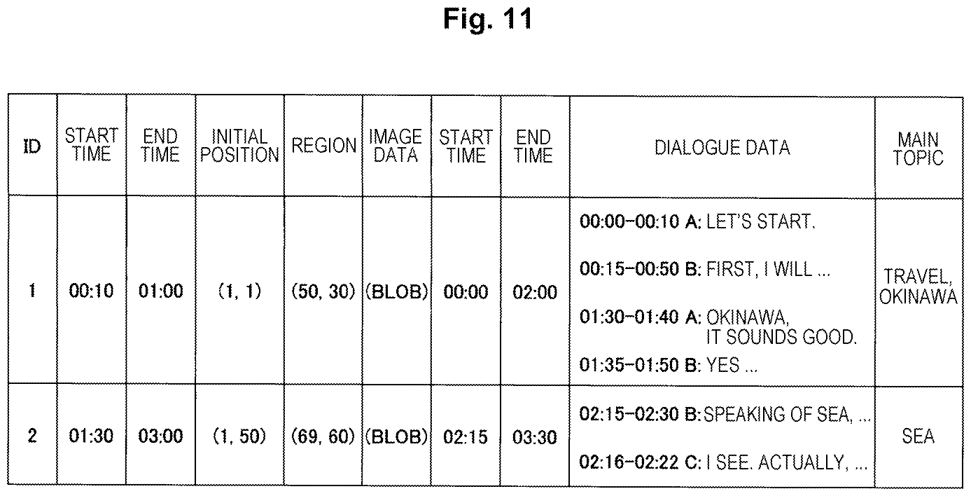

FIG. 11 is a view illustrating an example of the connected data after the integration. In FIG. 11, the concatenated data with ID=1 is an integration result of the concatenated data with ID=1 and the concatenated data with ID=2 in FIG. 10. Further, in FIG. 11, the concatenated data with ID=2 is an integration result of the concatenated data with ID=3 and the concatenated data with ID=4 in FIG. 10.

Specifically, for a connected data group having common region data, such as the connected data with ID=1 and ID=2 in FIG. 10, the association unit 17 generates one piece of connected data in which the region data and the integrated topic data are connected by integrating the topic data of the connected data group. Start time of the integrated topic data is a minimum value of the start time of each topic data of the integration source. End time of the integrated topic data is a maximum value of the end time of each topic data of the integration source. The dialogue data and the main topic of the topic data after the integration are results of simply combining the dialogue data or the main topic of each topic data of the integration source.

On the other hand, for a connected data group having common topic data, such as the connected data with ID=3 and ID=4 in FIG. 10, the association unit 17 generates one piece of connected data in which the integrated region data and the topic data are connected by integrating each region data of the connected data group. Start time of the region data after the integration is a minimum value of the start time of each region data of the integration source. End time of the region data after the integration is a maximum value of the end time of each region data of the integration source. Each of initial positions x and y of the region data after the integration is a minimum value of each of x and y of each region data of the integration source. Each of a width w and a height h of the region data after the integration is a value obtained by subtracting the values of x and y after the integration from maximum values of x+w and y+h of each region data of the integration source. Image data of the region data after the integration is image data obtained by combining the image data of each region data of the integration source.

Note that, in a case where the topic data is integrated, the integrated topic data becomes valid for the processing to be executed in response to input of the subsequent stroke. In addition, in a case where the region data is integrated, the integrated region data becomes valid for the processing to be executed in response to input of the subsequent stroke.

The association unit 17 stores one or more pieces of connected data (for example, the connected data illustrated in FIG. 11) newly generated by the processing procedure of FIG. 9 in the data storage unit 121. As a result, connected data generated in the past is stored in the data storage unit 121.

### [Operation Reception Unit 18]

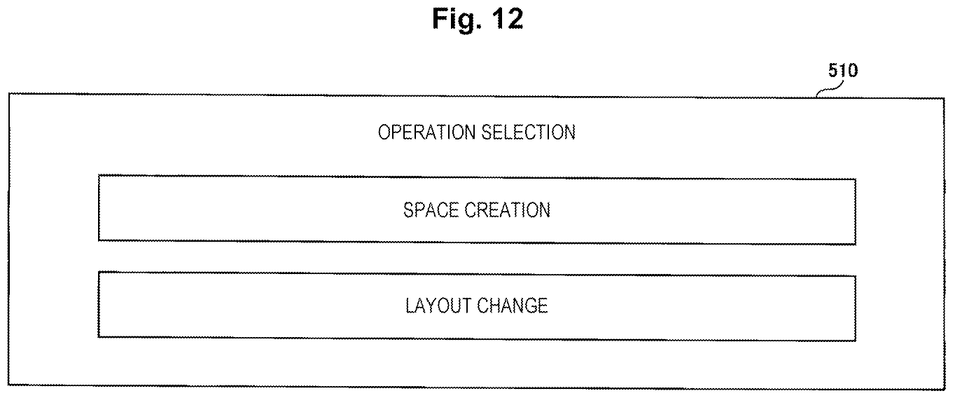

The operation reception unit 18 receives operation from a user. Operation using a physical button, a tablet that allows touch operation, a mouse, a keyboard, or the like, is considered as operation to be received. There are roughly two types of operation content: space creation (space creation in the drawing screen) at the time of creating a dialogue record (arbitrary timing during the dialogue); and layout change at the time of looking back on the dialogue record. In order to receive instructions related to these two types of operation content from the user, the operation reception unit 18 may display, for example, an operation selection screen 510 as illustrated in FIG. 12 on the display device 106.

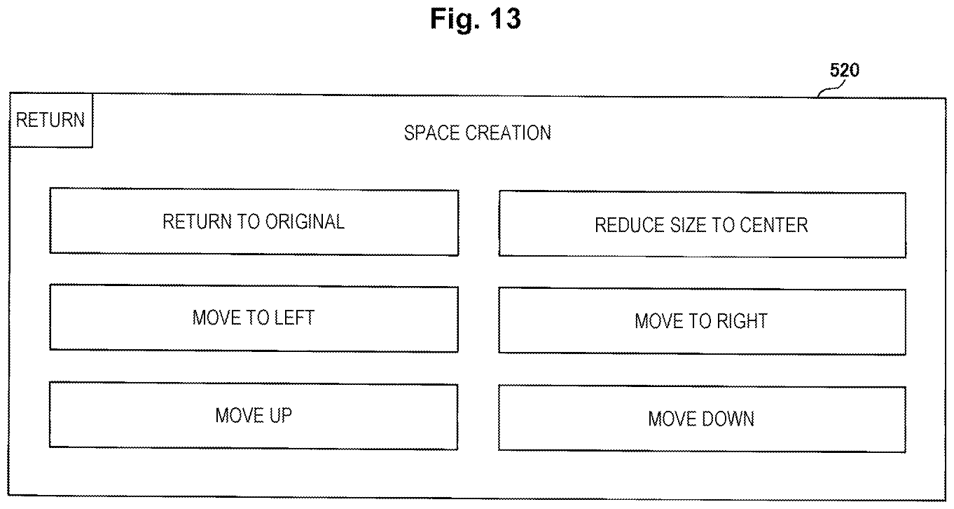

There are options for space creation such as “return to original”, “reduce size to center”, “move to left”, “move to right”, “move up”, and “move down”. In a case where “space creation” is selected on the operation selection screen 510, the operation reception unit 18 may display, for example, a space creation selection screen 520 as illustrated in FIG. 13 on the display device 106 to receive selection of any option from the user.

“Return to original” refers to reproducing the layout as it is at the time of creating the dialogue record. “Reduce size to center” refers to bringing drawn elements closer to the center of the screen. Here, the drawn element refers to image data of each connected data (FIG. 11) stored in the data storage unit 121. “Move to left” refers to moving the drawn elements to the left on the screen. “Move to right” refers to moving the drawn elements to the right on the screen. “Move up” refers to moving the drawn elements up on the screen. “Move down” refers to moving the drawn elements down on the screen.

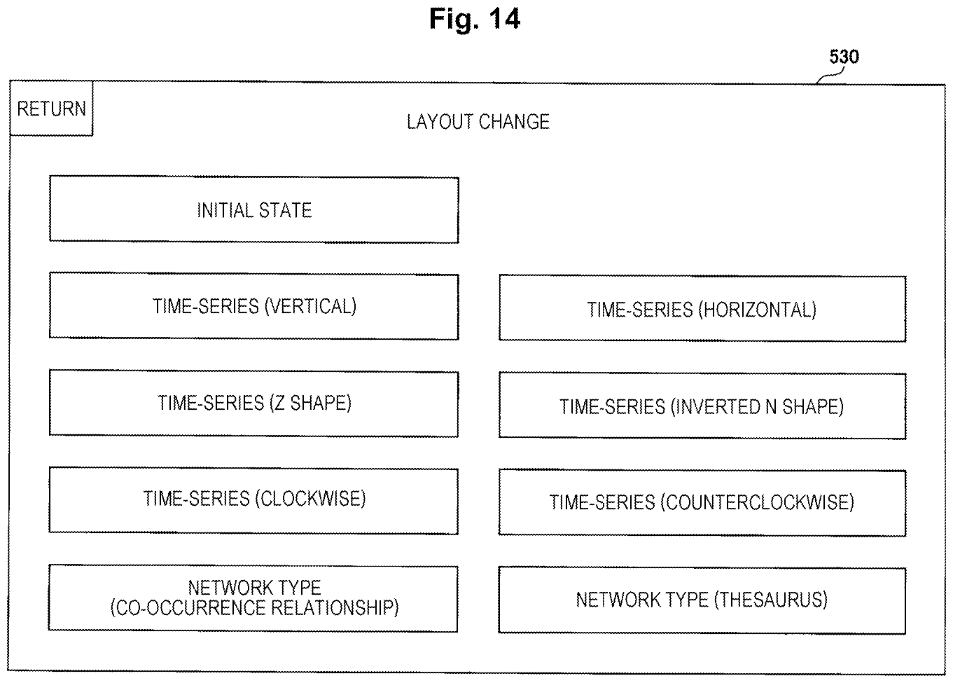

There are options of “initial state”, “time series (vertical)”, “time series (horizontal)”, “time series (Z shape)”, “time series (inverted N shape)”, “time series (clockwise)”, “time series (counterclockwise)”, “network type (co-occurrence relationship)”, “network type (thesaurus)”, and the like, for layout change. In a case where “layout change” is selected on the operation selection screen 510, the operation reception unit 18 may display, for example, a layout change selection screen 530 as illustrated in FIG. 14 on the display device 106 to receive selection of any of the options from the user.

The “initial state” refers to reproducing the layout as it is at the time of creating the dialogue record. “Time series (vertical)” refers to arranging drawn elements in time series from top to bottom. “Time series (horizontal)” refers to arranging drawn elements in time series from left to right. “Time series (Z shape)” refers to arranging drawn elements in time series in the order of upper left, upper right, lower left, and lower right. “Time series (inverted N shaper)” refers to arranging drawn elements in time series in the order of upper left, lower left, upper right, and lower right. “Time series (clockwise)” refers to arranging drawn elements in time series in a clockwise direction with the screen center as a rotation axis. “Time series (counterclockwise)” refers to arranging drawn elements in time series counterclockwise with the screen center as the rotation axis. “Network type (co-occurrence relationship)” refers to arranging drawn elements related to a set of dialogue data having a strong co-occurrence relationship between nouns and verbs acquired by morphological analysis among the dialogue data corresponding to each drawn element, close to each other. Strength of the co-occurrence relationship between the dialogue data may be evaluated on the basis of an appearance frequency of the same noun or verb. “Network type (thesaurus)” refers to arranging, among the dialogue data corresponding to each drawn element, drawn elements related to a set of dialogue data in which meanings of nouns acquired by morphological analysis are close to each other, close to each other. Note that closeness of the meaning of a noun may be evaluated using an existing thesaurus, or the like.

### [Layout Unit 19]

The layout unit 19 determines a position and a size of each drawn element on the drawing screen in accordance with a layout change instruction specified by the operation reception unit 18 for the connection data stored in the data storage unit 121 and outputs each drawn element at the determined position and size.

In a case where “return to original” or “initial state” is designated, the layout unit 19 sets coordinates for drawing each drawn element according to an initial position of each piece of connected data and draws each drawn element without changing the size of each drawn element. A drawing destination screen (hereinafter, referred to as a “layout screen”) may be a drawing screen or a screen different from the drawing screen.

In a case where “reduce size to center” is designated, the layout unit 19 reduces the size of each drawn element with a center of the layout screen as a base point and draws the drawn elements at positions close to the center of the layout screen. Note that, as a degree of reduction, a default value (for example, 75% reduction) may be set in advance, or an arbitrary value from 1 to 100% may be input by the user when changing the layout.

In a case where “move to left”, “move to right”, “move up”, or “move down” is designated, the layout unit 19 reduces the size of each drawn element and then draws the drawn elements at positions moved to an upper side, a lower side, a left side, or a right side of the screen.

In a case where “time series (vertical)” or “time series (horizontal)” is designated, the layout unit 19 determines drawing positions from top to bottom or from left to right in ascending order of “start time”, reduces the size of each drawn element to fit in the layout screen and then draws the drawn elements.

Similarly, also in a case where “time series (Z shape)”, “time series (inverted N shape)”, “time series (clockwise)”, or “time series (counterclockwise)” is designated, the layout unit 19 sets the position of each drawn element so as to draw a Z shape, an N mirror shape, a clockwise circle, or a counterclockwise circle in ascending order of “start time”, reduces the size of each drawn element so as to fit in the layout screen and then draws the drawn elements.

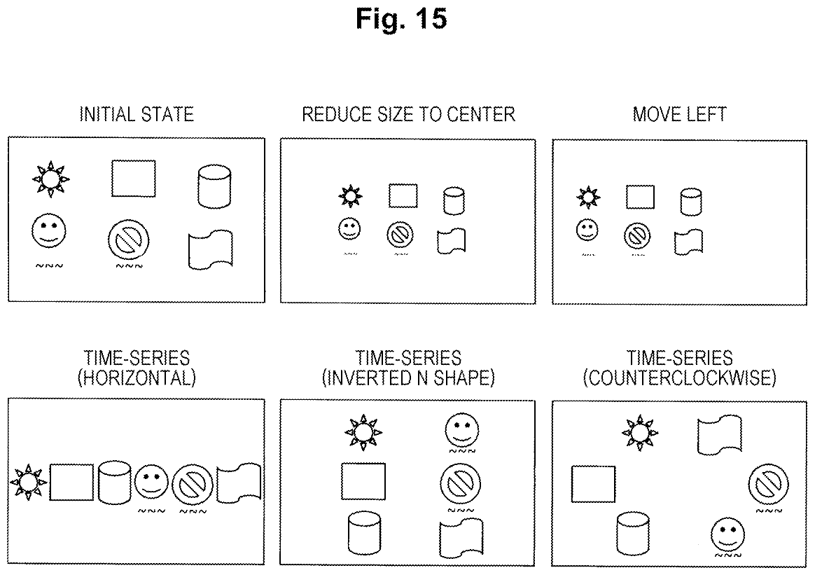

Note that FIG. 15 illustrates an example of a layout result in a case where “initial state”, “reduce size to center”, “move to left”, “time series (horizontal)”, “time series (inverted N shape)”, or “time series (counterclockwise)” is designated.

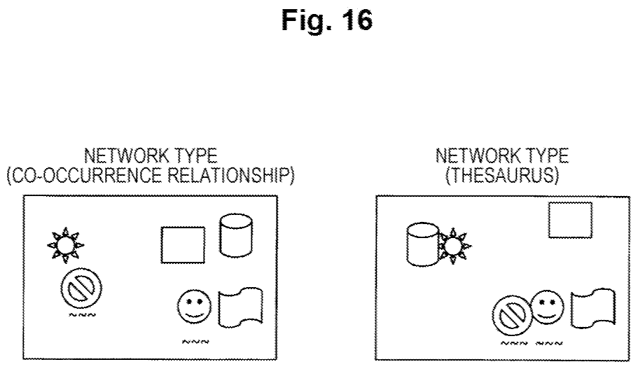

In a case where the “network type (co-occurrence relationship)” is designated, the layout unit 19 extracts nouns and verbs acquired by morphological analysis from the dialogue data corresponding to each drawn element, sets the position of each drawn element so that drawn elements having the same appearance frequency are drawn closer and draws the drawn elements. In a case where “network type (thesaurus)” is designated, the layout unit 19 acquires nouns from the dialogue data corresponding to each drawn element by morphological analysis, sets one of the drawn elements such that drawn elements related to nouns having similar meanings are close to each other using an existing thesaurus and draws the drawn elements. FIG. 16 illustrates an example of a layout result in a case where “network type (co-occurrence relationship)” or “network type (thesaurus)” is designated.

As described above, according to the present embodiment, regarding the graphical dialogue record utilizing the illustration or the photograph, the dialogue record can be segmented on the basis of behavior of the creator and the content of the discussion, and the layout of each drawn element can be changed. It is therefore possible to support creation of a dialogue record in which content of the dialogue is easily understood.

Furthermore, by changing a layout, it is possible to newly create a space for drawing a graphical dialogue record by changing the layout in the middle of the dialogue record for a dialogue record created by a less skilled dialogue record creator or a dialogue record such as open discussion in which an issue is not known in advance.

Furthermore, a person who browses the dialogue record can easily look back on the dialogue by changing the layout to a plurality of patterns.

In addition, the stroke of the frame line is excluded from a target of the layout, so that it is possible to prevent display of the frame line which is unnecessary information as a dialogue record.

In addition, image data, dialogue data, topic content (main topics), speakers, and the like, can be recorded in the data storage unit 121, so that it is also possible to make it possible to search for elements corresponding to the content of statement.

Note that, in the present embodiment, the topic recognition unit 12 is an example of a generation unit. The stroke input unit 13 is an example of an acquisition unit. The drawn content division unit 16 is an example of a division unit.

Although the embodiments of the present invention have been described in detail above, the present invention is not limited to such specific embodiments, and various modifications and changes can be made within the scope of the gist of the present invention described in the claims.

### REFERENCE SIGNS LIST

10 Layout device
11 Speech recognition unit
12 Topic recognition unit
13 Stroke input unit
14 Frame drawing detection unit
15 Pen type detection unit
16 Drawn content division unit
17 Association unit
18 Operation reception unit
19 Layout unit
100 Drive device
101 Recording medium
102 Auxiliary storage device
103 Memory device
104 CPU
105 Interface device
106 Display device
107 Input device
121 Data storage unit
B Bus

1. A layout method to be executed by a computer, the layout method comprising:
generating a plurality of pieces of second text data using a change in a topic in first text data generated by speech recognition for a speech of a dialogue as a separator;
acquiring a plurality of trajectories drawn in association with the dialogue;
the plurality of trajectories into a plurality of groups on a basis of drawn positions of the respective trajectories;
associating, for each of the groups, the second text data related to drawn content indicated by a group with the group and integrating groups associated with common second text data into one group; and
outputting, in response to a layout change instruction by a user, each group associated by said associating, a layout in accordance with the layout change instruction.

2. The layout method according to claim 1,
wherein, said dividing, if a positional relationship between a first trajectory and a second trajectory satisfies a predetermined condition and a difference between a drawing time of the first trajectory and a drawing time of the second trajectory is less than a predetermined period, the first trajectory and the second trajectory are included in the same group.

3. The layout method according to claim 2,
wherein, in said dividing, even in a case where the difference between the drawing time of the first trajectory and the drawing time of the second trajectory is equal to or greater than the predetermined period, if color of the first trajectory and color of the second trajectory are the same, the first trajectory and the second trajectory are included in the same group.

4. The layout method according to claim 1,
wherein, in said associating, the second text data is associated with the group on a basis of comparison between a character string obtained by character recognition for the drawn content indicated by the group and a character string included in the second text data.

5. The layout method according to claim 1, further comprising
determining, by the computer, whether or not each trajectory acquired by the acquisition step is a frame line for dividing drawn content indicated by the plurality of trajectories,
wherein, in step said dividing, the trajectory determined to be the frame line is not included in any of the plurality of groups.

6. A layout device comprising:
a hardware processor configured to
generate a plurality of pieces of second text data using a change in a topic in first text data generated by speech recognition for a speech of a dialogue as a separator,
acquire a plurality of trajectories drawn in association with the dialogue;
divide the plurality of trajectories into a plurality of groups on a basis of drawn positions of the respective trajectories;
associate, for each of the groups, the second text data related to drawn content indicated by a group with the group and integrate groups associated with common second text data into one group; and
output, in response to a layout change instruction by a user, each group associated unit with the second text data related to the drawn content indicated by the group in a layout in accordance with the layout change instruction.

7. A non-transitory computer-readable recording medium storing a program causing a computer to execute the layout method according to claim 1.
